(19) United States
(12) Patent Application Publication
(10) Pub. No.: US 2025/0105531 A1
(43) Pub. Date: Mar. 27, 2025

(54) Disconnecting power line connector

(71) Applicant: Romi, LLC., Baton Rouge, LA (US)

(72) Inventor: Robert Ensell, Bay City, MI (US)

(73) Assignee: Romi, LLC., Baton Rouge, LA (US)

(21) Appl. No.: 18/445,522

(22) Filed: Sep. 22, 2023

(51) Int. Cl. H01R 4/48; H01H 85/02; H01R 4/34; H01R 4/70

(52) U.S. Cl. CPC H01R 4/48; H01H 85/0241; H01R 4/34; H01R 4/70

(57) ABSTRACT

A break away electrical connector apparatus comprising a cylindrical fuse member with an electrically conductible blade member extending outwardly from each end of said fuse member, a fixed assembly mounted to one end of said blade member for connection to an electrical meter line, a separable assembly mounted to the other blade member end of said connector apparatus, said separable assembly including a clamp assembly which is mounted to and holds said other fuse blade member until a specific force is placed upon said separable assembly pulling it apart. The clamp assembly comprises a mounting member, adjacent separate clamp members mounted to said mounting member to hold a fuse blade member therebetween and means to connect said mounting member to an outside electrical line.

### RELATED APPLICATIONS

None

### STATEMENT REGARDING FEDERALLY SPONSORED RESEARCH OR DEVELOPMENT

None

### REFERENCE TO SEQUENCE LISTING, A TABLE OR A COMPUTER PROGRAM LISTING COMPACT DISC APPENDIX

None.

### BACKGROUND OF THE INVENTION

### 1. Field of Invention

The present invention generally relates to a disconnecting power line connector. More particularly, the present invention relates to a power line connector apparatus which disconnects from the associated meter or connector point without damage when hit by a tree limb or other debris with a predetermined force.

### 2. Background of the Invention

Presently electrical power lines are connected to a building structure directly from a transformer to an associated meter. Generally, the meter has a length of rigid conduit that extends upwards a safe height from the meter and the electrical lines run from the transformer through the conduit to the meter and structure.

The electrical lines consist of three or more wires, including at least two power lines and one neutral ground wire. The neutral ground wire is a steel reinforced wire that is connected to the structure or building via a house/building insulator. The neutral ground wire is what holds the tension of the power line in order to maintain its general horizontal attitude at a safe height from the pole to the building structure.

When unforeseen events such as storms, high winds or weather conditions occur causing fallen trees or tree limbs or other debris come into forceful contact with the electrical lines causing these lines to rip out and be disconnected from the meter and/or the structure the electrical service is wiped out. In such a circumstance the home insulator is generally ripped from its mounting point on the structure and frequently the conduit and power meter is pulled away from the structure or building. This engagement not only has the potential to destroy the electrical equipment but can damage the mounting hardware and cause collateral damage to the structure's exterior finish and structural integrity. Such occurrences can also cause expensive and time consuming repairs at the owner's expense. When the power line is down the connected equipment does not operate and there is no generation of revenue for the electrical utility. In addition, people and product resources must be allocated as soon as possible to mitigate the danger of the downed line and get the line up and working as fast as possible. Such repairs are also subject to supply chain problems and personal shortages.

Thus, there is a need to reduce and prevent the problem of power line severance from the associated building and eliminate collateral damage.

None of the present prior art attempts have satisfactorily solved the problems noted above, and known teachings do not aid in the resolution of a number of practical difficulties that are resolved by the present invention.

### SUMMARY OF THE INVENTION

The present disconnecting power line connector apparatus can be connected both at the transformer and the weather head or at just one end. The inventive connector serves as a safety breaker. If the line breaks, the apparatus disconnects from the transformer, thus the weather head or meter is not damaged on the home or structure and the line on the ground is now a dead line and not electrified. If the line disconnects from the house or building it is still a live line, however the insulating jacket completely encapsulates the end of the disconnected line, therefore it is safer than bare wires lying on the ground but is still hot.

The present invention describes an apparatus which is constructed to disconnect and separate when engaged by an object such as a tree limb traveling with sufficient force without destroying the building, meter and associated equipment.

It is an object of the invention to provide separation of the power line from the building when engaged to limit damage to the connected apparatus and to its associated building structure.

It is another object of the invention to allow easy repair to the power connector and associated equipment.

It is yet another object of the invention that by adding a fuse of correct amperage e.g. 100 amp, to the device it helps prevent a power surge from damaging the building and devices plugged into the building. The invention can be built in any required amperage.

### BRIEF DESCRIPTION OF THE DRAWINGS

The present invention will be described with reference to the appended Figures, in which:

FIG. 1 is a perspective view of the disconnecting power line connector invention;

FIG. 2 is a top plan view of the disconnecting power line connector invention shown in FIG. 1;

FIG. 3 is a side elevational view of the disconnecting power line connector invention shown in FIG. 2;

FIG. 4 is a cross sectional view of the disconnecting power line connector taken along line A-A of FIG. 3;

FIG. 5 is a cross sectional view of the disconnecting power line connector taken along line B-B of FIG. 3;

FIG. 6 is a perspective view of the front clamp assembly of the disconnecting power line connector invention separated from the fuse body;

FIG. 7 is a top plan view of the disconnecting power line connector of FIG. 6;

FIG. 8 is a side and partial cross sectional view of disconnecting power line connector of.

FIG. 7;

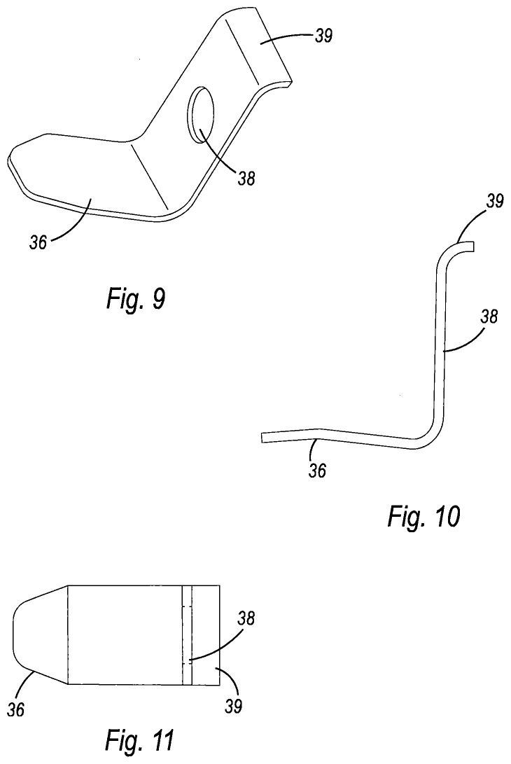

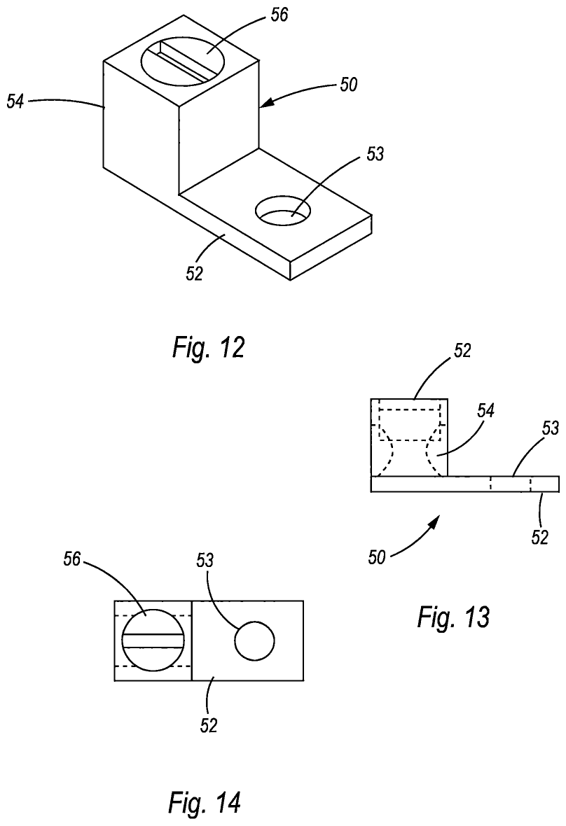

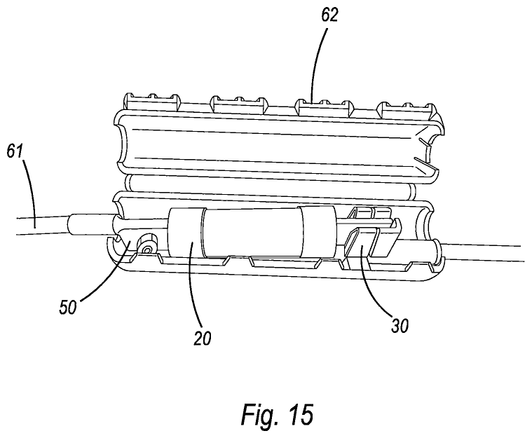

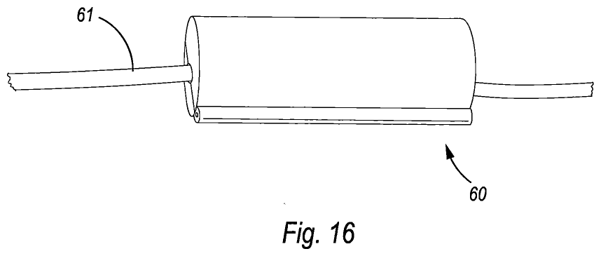

FIG. 9 is a perspective view of the holding bracket shown in FIG. 8;

FIG. 10 is a side elevational view of holding bracket of FIG. 9 showing the preferred angles between the extended arms of the holding bracket;

FIG. 11 is a top plan view of the holding bracket shown in FIG. 10;

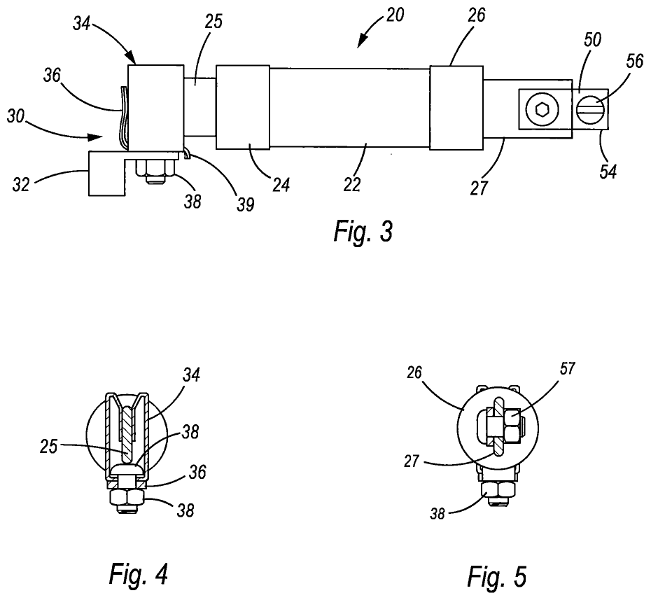

FIG. 12 is a perspective view of the rear holding member of the disconnecting power line connector shown in FIGS. 2 and 3;

FIG. 13 is a side elevation view partially in phantom of the rear holding member of the disconnecting power line connector of FIG. 12;

FIG. 14 is a top plan view of the rear holding member of the disconnecting power line connector of FIG. 12.

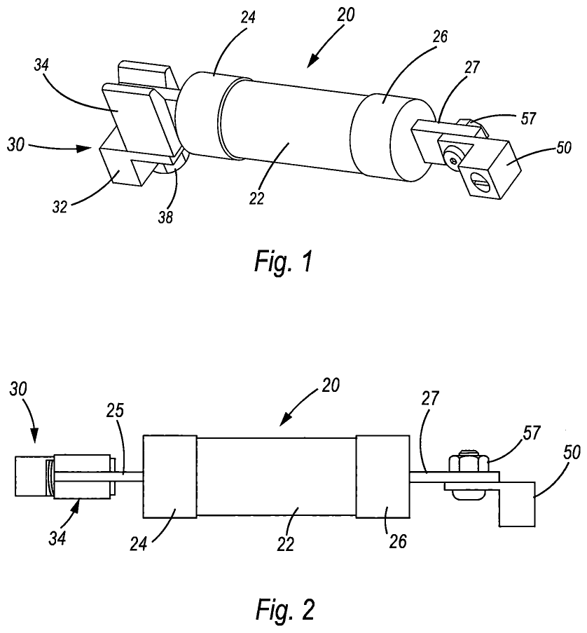

FIG. 15 is the disconnecting power line connector shown in FIGS. 1-3 mounted in an open insulating container; and

FIG. 16 is a perspective view of the disconnecting power line connector of FIG. 15 encased in a closed insulating container.

These and other objects, advantages, and novel features of the present invention will become apparent when considered with the teachings contained in the detailed disclosure along with the accompanying drawings.

### DESCRIPTION OF THE INVENTION

Use of the singular herein includes the plural and vice versa unless expressly stated to be otherwise, or obvious from the context that such is not intended. That is, “a” and “the” refer to one or more of whatever the word modifies. For example, “a device” includes one device, two devices, etc.

Also, words of approximation when used herein such as, without limitation, “about” “substantially,” “essentially” and “approximately” mean that the word or phrase modified by the term need not be exactly that which is written but may vary from that written description to some extent. The extent to which the description may vary will depend on how great a change can be instituted and have one of ordinary skill in the art recognize the modified version as still having the properties, characteristics and capabilities of the modified word or phrase. In general, but with the preceding discussion in mind, a numerical value herein that is modified by a word of approximation may vary from the stated value by plus or minus 15%, unless expressly stated otherwise.

The aspects of the present invention are described in the following paragraphs along with their preferred embodiments.

The disconnecting connector apparatus 20 is preferably constructed of metal parts and a fuse amp but it is also envisioned that plastic parts of suitable strength can be substituted for one or more of the metal parts.

The disconnecting connector apparatus 20 connects the power line 61 supplying the structure and the building and the power line 64 at the top of a conduit (not shown) leading from the meter as seen in FIGS. 15 and 16. The connector body 22 preferably is an appropriately cylindrically shaped fuse having end caps 24 and 26. Each end cap has an outwardly extending metal or electrical conducting blade 25 and 27 respectively. In the disclosed embodiment a 100 amp cylindrical shaped fuse is used. It should also be noted that smaller or larger fuses can be used for different applications. The connector release assembly 30 is designed to break or pull away at a specific PSI which is lower than that which would be required to rip out the service of the building, thus avoiding the costly and time consuming repair of fixing the structure, replacing the conduit and the meter. It is also designed to disconnect at a specific PSI which is lower then that of the rear fastener if the same structure is used to connect the tension power line to a rear connector device. In addition, the repair can be done much faster thus returning the line to operating and revenue generating status and lessening the hazards of a downed line.

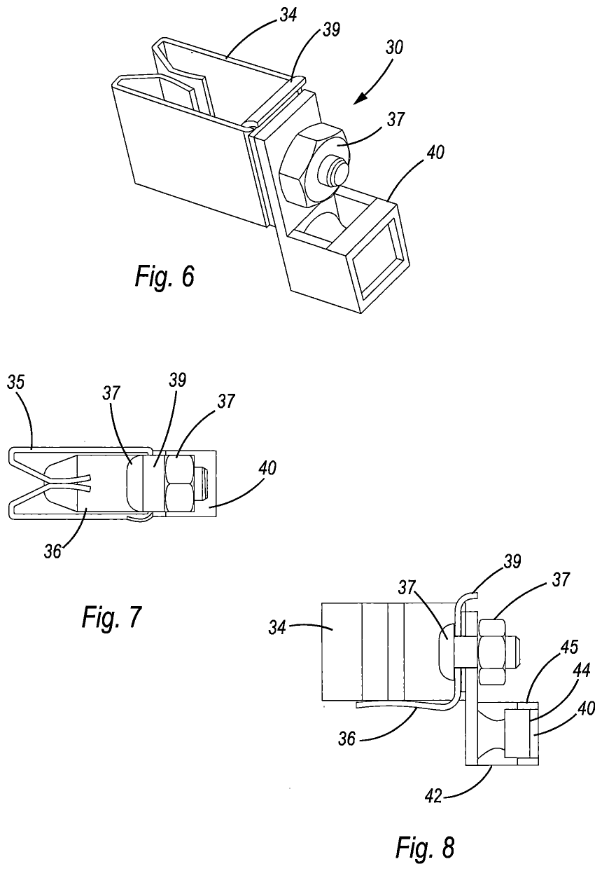

The connector release or separation assembly 30 as seen in FIGS. 2-8 has a base member 32 which is mounted to the electrical power line in clamp pressure mount 34. Connector blade 25 extending from fuse body 22 is inserted into the clamp pressure mount assembly 34 as seen in FIG. 4. The clamp pressure mount 34 is held on a pressure support plate 36 (shown in FIGS. 7 and 8) by a nut and bolt assembly 37 which is inserted through aperture 38 and screwed into a closed position. The top curved end 39 of the pressure support plate 36 extends over the back of the clamp mount. A wire mount 40 is secured to the pressure support plate 36 by bolt and nut assembly 37 as seen in FIG. 8 and defines a throughgoing chamber 42 which holds the power line (not shown). A set screw 44 is threaded at 45 to be able to lock the power line into the chamber 42. The fuse blade 25 is inserted between the loop springs 35 as seen in FIG. 2 holding the fuse blade 25 in a fixed position.

The connector assembly 20 connects to the power line using block lugs and a clamp assembly 34 connected to the disconnecting fuse assembly. The connector is designed to be conveniently installed by an electrician by using the simple bolt and nut attachment. The installer simply bolts the respective power lines to the end blades of the connector 20. After installation, when circumstances force the line down, the connector clamp and body will break away from the structure's mounting point. In a repair an installer would simply replace the connector 20 as there would be minimal damages to the structure.

As shown in FIGS. 12 through 14 a meter wire locking assembly 50 is mounted to blade 27 by a bolt and nut fastener 57 which are mounted through a throughgoing aperture 53 of extending arm 52 which extends from wire holding box 50. The wire holding rectangular box 50 is integrally formed with an extending arm 52 and forms a chamber to hold the metering wire therein by tightening screw 56 which is mounted in the box. Blade 27 defines an aperture which is axially aligned with aperture 53 of extending arm 52 to receive a nut and bolt fastener 57 holding the blade 27 and arm 52 together.

In addition to providing enhanced safety features to the cost effective and timely repairs the inventive connector also provides enhanced safety features to the structure. For example, the service connector can be disconnected from the structure by a trained professional, such as a firefighter using a hot stick which will cut power to the structure and save valuable time for fighting fires. The inventive device also provides another line of safety by providing electrical current protection between the main power line and the power meter which is currently non-existent in similar meters today, thus protecting the structure and all electrical devices from a current overload. The inventive connector provides a quick and reliable disconnect point for the main power supply in the event the main breaker is overloaded or frozen on.

The disconnecting connector apparatus is mounted in an insulated fire proof casing 60 as shown in FIGS. 15 and 16. The insulated casing 60 is preferably constructed of plastic or plastic and rubber and can be easily opened as seen in FIG. 15 to expose the disconnecting connector apparatus for inspection or repairs. The cover 62 is then snapped shut to provide an enclosed container or casing 60 for the disconnecting connector apparatus as shown in FIG. 16.

The application for the present invention has several benefits: (1) If an electrical line goes down it is not “hot” and thus it's safe and (2) Much faster processing of restoring downed electrical lines thus getting lines back to revenue generating status and customers with electricity.

In order to understand the use of the invention one should envision that when electrical lines are connected to a home, there are 3 or more lines that feed into the weather head and attach . . . to the meter. There is also a tension cable that is used for tension to keep the lines relatively horizontal and not sagging to the ground. This tension line is connected between the power pole and the home with a metal eyelet. The actual electrical lines don't really have any pressure or tension on them.

When a limb falls or any other event that causes the line to break, the line normally rips down the house, rips out the weather head and rips the meter off the wall causing significant damage and posing a fire danger as a downed power line is usually hot (electrified) unless it breaks at the source.

The service savers could be connected both at the transformer and the weather head, or at just one end. The preferable application would be both ends: The service saver serves as a safety breaker. If the line breaks, the device disconnects thus the weather head is not damaged on the home and the line on the ground is now a dead line (not electrified) if it broke at the transformer. As noted in the preferred application the apparatus disconnect could be at both ends.

The tensioner on the telephone pole is usually an eyelet bolt that extends all the way through the pole and is thus much stronger than the tensioner eyelet on a house which is just screwed into the wood of the house, thus in most cases when something causes the line to break, it will break at the house and thus it would be a “hot line” on the ground. With the insulation container addition to the device it would be insulated and thus be significantly safer.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A disconnecting electrical connector apparatus comprising a cylindrical fuse member with electrically conductible blades extending outwardly from each end of said fuse member, a fixed assembly mounted to one end of said fuse member for connection to an electrical meter line, a disconnect assembly mounted to the other end of said connector apparatus, said disconnect assembly including a clamp assembly which holds said other end of said fuse blade member until a specific force is placed upon said disconnect assembly, and an insulating member mounted around said cylindrical fuse member.

2. A disconnecting electrical connector apparatus as claimed in claim 1 wherein said clamp assembly comprises a mounting member, a clamp assembly in the form of two adjacent clamp members mounted to said mounting member to hold a fuse blade bar therebetween under predetermined force and means to connect said mounting member to an outside electrical line.

3. A disconnecting electrical connector apparatus as claimed in claim 1 including an insulated closable casing holding said cylindrical fuse member and disconnect assembly.

4. A disconnecting electrical connector apparatus as claimed in claim 1 wherein said spring member comprises two opposed metal plates which engage and hold an end blade member under a predetermined force.

5. A disconnecting electrical connector apparatus as claimed in claim 1 wherein said clamp member is mounted on a seat member which is engaged and held on a block member by a nut and bolt.

6. A disconnecting electrical connector apparatus as claimed in claim 5 wherein said seat member has an L shaped body defining a throughgoing aperture.

7. A disconnecting electrical connector apparatus comprising a cylindrical fuse member with an electrically conductible blade member extending outwardly from each end of said fuse member, a fixed assembly mounted to one end of said blade member for attachment to an outside electrical connection to an electrical meter line, a separable assembly mounted to the other blade member end of said connector apparatus, said separable assembly including a clamp assembly which is mounted to a mounting member and holds said other fuse blade member until a specific force is placed upon said separable assembly pulling it apart, said clamp assembly comprises a mounting member, said mounting member being mounted to a power line mounting member, a clamp assembly mounted to said mounting member to hold a fuse blade member therebetween, means to connect said mounting member to an outside electrical line and an insulative container to hold said cylindrical fuse member, associated blades and related other assemblies.

8. A disconnecting connector member as claimed in claim 7 wherein said means to connect said mounting member to an outside electrical line is a seat member provided with means to engage and hold an electrical power line.

9. A disconnecting connector member as claimed in claim 8 wherein said seat member has a substantially L shape with the distal ends of the legs of said L shape seat member forming an angle of about 95 degrees and the closed center portion forming an angle of about 85 degrees.

10. A disconnecting connector member as claimed in claim 7 wherein said means to connect said mounting member to an outside electrical line is a seat member provided with means to engage and hold an electrical power line.

11. A disconnecting electrical connector apparatus comprising a cylindrical fuse member with an electrically conductible blade member extending outwardly from each end of said fuse member, a fixed assembly mounted to one said blade member for attachment to an outside electrical connection to an electrical meter line, a separable assembly mounted to the other blade member end of said connector apparatus, said separable assembly including a clamp assembly which is mounted to a mounting member and holds said other fuse blade member until a specific force is placed upon said separable assembly pulling it apart, said clamp assembly comprises a mounting member, said mounting member being mounted to a power line mounting member, a clamp assembly mounted to said mounting member to hold a fuse blade member therebetween and means to connect said mounting member to an outside electrical line.

12. A disconnecting electrical connector apparatus as claimed in claim 11 wherein said cylindrical fuse member has an insulated member mounted thereto.

13. A disconnecting electrical connector apparatus as claimed in claim 11 wherein said fuse member, mounted blade members, fixed assembly and separable assembly are mounted in an insulated container having opening means allowing access to said members and assemblies.

14. A disconnecting electrical connector apparatus as claimed in claim 11 wherein said clamp assembly comprises a mounting member, adjacent clamp bars mounted to said mounting member to hold a fuse blade therebetween and means to connect said mounting member to an outside electrical line.

15. A disconnecting electrical connector apparatus as claimed in claim 11 wherein said fuse member is a 100 amp fuse.

16. A disconnecting electrical connector apparatus as claimed in claim 1 wherein said spring member comprises two opposed metal plates which engage and hold an end blade member under a predetermined force.

17. A disconnecting electrical connector apparatus as claimed in claim 11 wherein said clamp member is mounted on a seat member which is engaged and held on a block member by a nut and bolt.

18. A disconnecting electrical connector apparatus as claimed in claim 11 wherein said seat member has an L shaped body defining a throughgoing aperture.

19. A disconnecting electrical connector apparatus as claimed in claim 13 wherein said insulated container is constructed of fireproof plastic material.
